(19) United States
(12) Patent Application Publication
(10) Pub. No.: US 2026/0364452 A1
(43) Pub. Date: Nov. 19, 2026

(54) SERVER DEVICE AND INFORMATION PROCESSING DEVICE

(71) Applicant: SONY INTERACTIVE ENTERTAINMENT INC., Tokyo (JP)

(72) Inventor: Nobuyuki NAKAMURA, Kanagawa (JP)

(73) Assignee: Sony Interactive Entertainment Inc., Tokyo (JP)

(21) Appl. No.: 19/148,074

(22) PCT Filed: Feb. 8, 2023
(86) PCT No.: PCT/JP2023/004194

§ 371 Date: Jul. 15, 2025

(51) Int. Cl. A63F 13/533; A63F 13/35; A63F 13/79; A63F 13/837

(52) U.S. Cl. CPC A63F 13/533; A63F 13/35; A63F 13/79; A63F 13/837

(57) ABSTRACT

A play history identifying section 214 acquires a history of play data of a user who is playing a game. When a withdrawal determining section 216 determines from the history of the play data of the user that there is a high possibility that the user will withdraw from the game, a play assistance section 218 performs an assistance process related to a game play before the user ends the game play.

### TECHNICAL FIELD

The present disclosure relates to a technology for assisting a user in playing a game.

### BACKGROUND ART

PTL 1 discloses a server device that collects and statistically processes event data relating to an activity played by a plurality of players. The server device derives an expected play time for the activity on the basis of the event data of the plurality of players.

### CITATION LIST

### Patent Literature

[PTL 1] JP 2022-63756A

### SUMMARY

### Technical Problem

By collecting play data indicating the situations in which a plurality of players have played a game, the server device can derive various types of information through statistical processing, machine learning, etc., and can assist the user's game play. The present disclosure aims to achieve a technology for performing an assistance process related to the user's game play.

### Solution to Problem

One aspect of the present invention is a server device including one or more processors having hardware. The one or more processors acquire a history of play data of a user who is playing a game, and perform an assistance process related to a game play before the user ends the game play, in a case of determining from the history of the play data of the user that there is a high possibility that the user withdraws from the game.

Another aspect of the present invention is an information processing device operated by a user, the device including one or more processors having hardware. The one or more processors transmit play data of the user who is playing a game to a server device, and present support information to the user or provide the support information to the game, the support information being transmitted from the server device on the basis of a history of the play data of the user.

It should be noted that any combination of the above components, and converted items of the expression of the present disclosure into a method, a device, a system, a recording medium, a computer program, etc., are also valid aspects of the present disclosure.

### BRIEF DESCRIPTION OF DRAWINGS

FIG. 1 is a diagram illustrating an information processing system according to an embodiment.

FIG. 2 is a diagram illustrating a hardware configuration of an information processing device.

FIG. 3 is a diagram illustrating functional blocks of the information processing device.

FIG. 4 is a diagram illustrating functional blocks of a server device.

FIG. 5 is a diagram illustrating examples of past play patterns by a plurality of players.

FIG. 6 is a diagram illustrating an example of a system screen.

FIG. 7 is a diagram illustrating another example of the system screen.

FIG. 8 is a diagram illustrating still another example of the system screen.

FIG. 9 is a diagram illustrating an example in which game software adjusts a game difficulty level.

### DESCRIPTION OF EMBODIMENT

In an embodiment, an information processing device which is a user terminal device executes game software. When an event occurs in the game, the game software outputs event information including information that identifies the event that has occurred (event ID (Identification)) to the system software. An event occurs when there is a change in the game progress, a change in the behavior of a game character, or the like.

A game includes a plurality of activities in which a start condition and an end condition are set. The activity is a unit of play that includes a stage, quest, mission, tournament, session, and the like incorporated in the game. The game progress from when the start condition is satisfied to when the end condition is satisfied constitutes one activity. The activities are set appropriately by a game maker. For example, one quest that appears in the game progress may constitute one activity, or a plurality of quests may constitute one activity. In the case where a plurality of quests constitute one activity, the end condition for that activity is to complete all of the plurality of quests.

It should be noted that the game maker may set all stages, quests, missions, tournaments, and sessions incorporated into the game as activities, or may set only some stages, quests, missions, tournaments, and sessions as activities. As described above, one activity may be set for a combination of a plurality of quests and missions to form one play unit. In this way, the elements that constitute an activity may be specified as desired by the game maker.

When starting an activity, the game software outputs event information including information identifying the start event of the activity (event ID) to the system software. Further, when ending an activity, the game software outputs event information including information identifying the end event of the activity (event ID) to the system software. In addition to the event ID, the event information may include information identifying the activity (activity ID), and may also include information indicating the result of the activity (e.g., success or failure). The event ID is set to be different for each activity.

Note that events may be set not only for activities but also for various occurrences or states occurring in the game. For example, events may be set for actions of a character operated by a player (player character), such as equipping itself with a weapon, using a recovery medicine, or strengthening protective gear. When an event occurs during the progress of the game, the game software outputs event information including information identifying the event (event ID) to the system software. While a user is playing the game, the game software preferably outputs various types of event information to the system software.

The system software generates event data (hereinafter also referred to as “play data”) in which a user identifier that identifies the user (user account), a game identifier that identifies the game (game ID), and time information (time stamp) are added to the event information output from the game software, and automatically transmits the event data to an external server device.

In the embodiment, the server device collects play data (event data) transmitted from a plurality of information processing devices operated by a plurality of players (users) and analyzes the play patterns of players who quit the game midway. Here, the play pattern is information indicating how a player has played the game before quitting. By the server device having identified the play pattern of a player who has quit the game midway (hereinafter also simply referred to as “withdrawing player”), it becomes possible to predict that a player who proceeds with the game with the same play pattern is likely to quit the game later.

In the embodiment, a withdrawing player is typically a player who completely avoids playing a game after having finished playing the game. In principle, although a player who finished playing a game and then resumed playing the game after a period of suspension does not qualify as a withdrawing player, in the case where the period of suspension is long (for example, approximately half a year), the player may be considered as a withdrawing player. In the case of a game with a goal, such as a role-playing game or an adventure game, if a player has already cleared the game, the user does not qualify as a withdrawing player even if the player has avoided playing the game. However, a player who has not yet cleared the game and has not resumed playing the game is considered to be a withdrawing player.

By analyzing the play pattern of a player who has withdrawn and the play pattern of a player who has not withdrawn and comparing the two patterns, the server device can derive a play pattern specific to the player who has withdrawn. As an example, a play pattern is derived in which a player who has played an activity A, an activity D, an activity H, and an activity J in this order without equipment is likely to withdraw at the activity J, while a player who has played the activity A to the activity J via another activity is unlikely to withdraw at the activity J. Also, a play pattern may be derived in which a player who has played the activity A, the activity D, the activity H, and the activity J in this order with equipment is unlikely to withdraw. By identifying the degree of the possibility of withdrawal in association with the play pattern in advance, the server device can predict that a player who follows the same play pattern as a past withdrawing player is likely to withdraw.

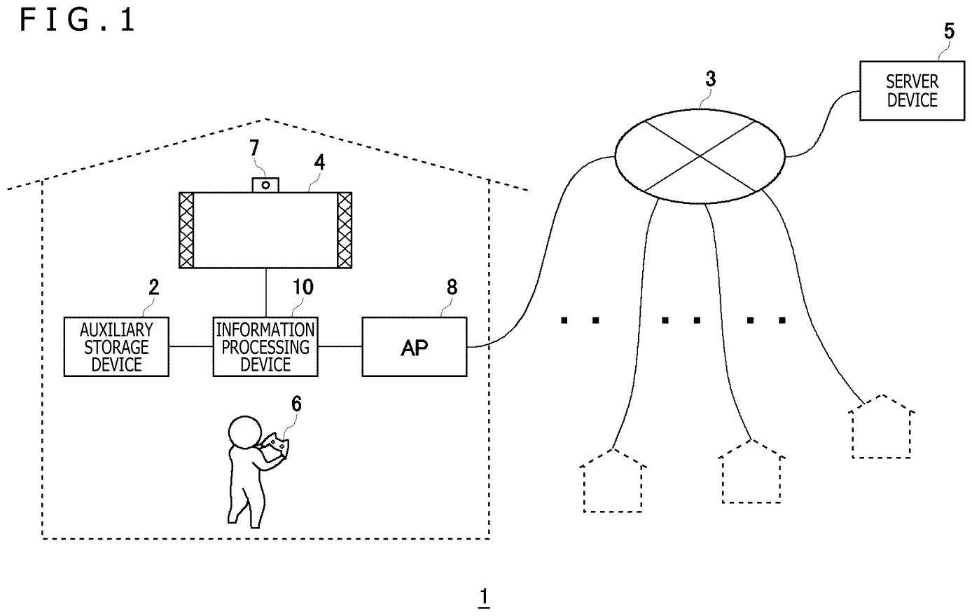

FIG. 1 illustrates an information processing system 1 according to the embodiment of the present disclosure. The information processing system 1 according to the embodiment is a game system that supports a user's game play, and includes an information processing device 10 operated by a user and a server device 5. An access point (hereinafter, referred to as an “AP”) 8 has the functions of a wireless access point and a router, and the information processing device 10 connects to the AP 8 in a wired or wireless manner to be communicably connected to the server device 5 on a network 3 such as the Internet. Although FIG. 1 illustrates one user and one information processing device 10, in the information processing system 1, a plurality of information processing devices 10 operated by a plurality of users are connected to the server device 5 via the network 3.

The information processing device 10 is connected in a wired or wireless manner to an input device 6 operated by a user, and the input device 6 outputs information regarding an operation made by the user to the information processing device 10. When receiving the operation information from the input device 6, the information processing device 10 reflects the information in the processing performed by system software and game software and causes an output device 4 to output the processing result. In the information processing system 1, the information processing device 10 is a game device (game console) that executes a game, and the input device 6 is a device that supplies user operation information to the information processing device 10, such as a game controller. Note that the input device 6 may be an input interface such as a keyboard or a mouse.

An auxiliary storage device 2 is a large-capacity storage device such as an HDD (hard disk drive) or an SSD (solid state drive), and may be a built-in storage device or an external storage device connected to the information processing device 10 via a USB (Universal Serial Bus) or the like. The output device 4 may be a television having a display for outputting images and a speaker for outputting sounds. The output device 4 may be connected to the information processing device 10 via a wire cable or wirelessly.

A camera 7 which is an imaging device is provided near the output device 4 and captures an image of the space around the output device 4. Although an example in which the camera 7 is attached to the top of the output device 4 is illustrated in FIG. 1, the camera 7 may be disposed on the side or bottom of the output device 4, and in any case, the camera 7 is disposed in such a position as to be able to capture an image of a user positioned in front of the output device 4. The camera 7 may be a stereo camera.

The server device 5 provides network services to users of the information processing system 1. The server device 5 manages user accounts that identify the respective users, and each user signs in to the network service provided by the server device 5, by using the user account. By signing in to the network service from the information processing device 10, the user can register game save data and trophies which are virtual awards acquired during game play, in the server device 5. By registering the save data and trophies in the server device 5, the save data and trophies can be synchronized even if the user uses an information processing device other than the information processing device 10.

The server device 5 according to the embodiment collects play data indicating the status of game play from the plurality of information processing devices 10. In the embodiment, the play data is event data including event information output by the game software. The server device 5 may identify, for each game, the play pattern of a player who has withdrawn from the game. In the embodiment, “withdrawn from the game” means that a player has withdrawn from the game for a long period of time or semi-permanently, and does not mean that a player has withdrawn from the game temporarily (for a short period of time such as a few days).

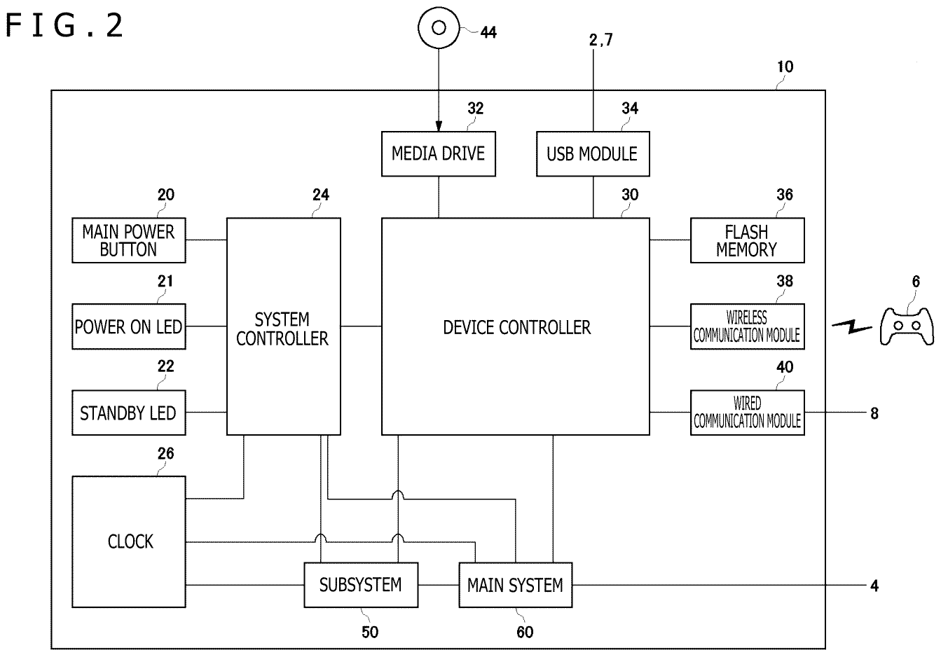

FIG. 2 illustrates a hardware configuration of the information processing device 10. The information processing device 10 includes a main power button 20, a power ON LED (Light Emitting Diode) 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main system 60 includes a main CPU (Central Processing Unit), a memory and a memory controller serving as a main storage device, a GPU (Graphics Processing Unit), etc. The GPU is mainly used for arithmetic processing of the game program. The main CPU has a function 41 starting up the system software and executing the game program installed in the auxiliary storage device 2 in the environment provided by the system software. The subsystem 50 has a sub-CPU, a memory and a memory controller serving as a main storage device, etc., but does not include a GPU.

The main CPU has the function of executing a game program installed in the auxiliary storage device 2, while the sub-CPU does not have such a function. However, the sub-CPU has a function of accessing the auxiliary storage device 2 and a function of sending and receiving data to and from the server device 5. The sub-CPU has only such limited processing functions, and therefore can operate with small power consumption compared to the main CPU. These functions of the sub-CPU are executed when the main CPU is in a standby mode.

The main power button 20 is an input unit through which a user inputs operations, and is provided on the front of the housing of the information processing device 10 to be operated to turn on or off the power supply to the main system 60 of the information processing device 10. The power ON LED 21 lights up when the main power button 20 is turned on, and the standby LED 22 lights up when the main power button 20 is turned off. The system controller 24 detects that the main power button 20 has been pressed by the user.

The clock 26 is a real-time clock that generates current date and time information and supplies the information to the system controller 24, the subsystem 50, and the main system 60.

The device controller 30 is configured as an LSI (Large-Scale Integrated Circuit) that performs information transfer between devices, like a south bridge. As illustrated in FIG. 2, devices such as the system controller 24, the media drive 32, the USB module 34, the flash memory 36, the wireless communication module 38, the wired communication module 40, the subsystem 50, and the main system 60 are connected to the device controller 30. The device controller 30 absorbs differences in electrical characteristics and data transfer speeds of the various devices and controls the timing of data transfer.

The media drive 32 is a drive device that is driven while being equipped with a ROM (Read-Only Memory) medium 44 on which application software and license information of games or the like are recorded, and that reads out programs, data, and the like from the ROM medium 44. The ROM medium 44 is a read-only recording medium such as an optical disk, a magneto-optical disk, or a Blu-ray disk.

The USB module 34 is a module that connects to an external device via a USB cable. The USB module 34 may be connected to the auxiliary storage device 2 and the camera 7 via USB cables. The flash memory 36 is an auxiliary storage device that constitutes an internal storage. The wireless communication module 38 wirelessly communicates with the input device 6 by using a communication protocol such as a Bluetooth (registered trademark) protocol or an IEEE (Institute of Electrical and Electronics Engineers) 802.11 protocol. The wired communication module 40 communicates with an external device via a wired communication and connects to the network 3 via the AP 8.

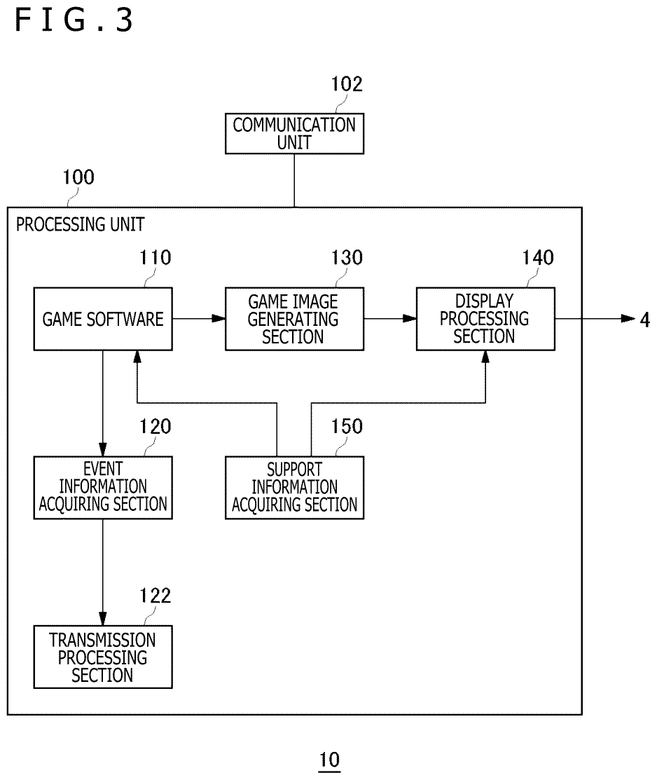

FIG. 3 illustrates functional blocks of the information processing device 10. The information processing device 10 includes a processing unit 100 and a communication unit 102. The processing unit 100 includes game software 110, an event information acquiring section 120, a transmission processing section 122, a game image generating section 130, a display processing section 140, and a support information acquiring section 150.

The information processing device 10 includes a computer, and various functions illustrated in FIG. 3 are achieved by the computer executing programs. The computer includes, as hardware, a memory for loading the programs, one or more processors for executing the loaded programs, an auxiliary storage device, and other LSIs, for example. The processor includes a plurality of electronic circuits including a semiconductor integrated circuit and an LSI, and the plurality of electronic circuits may be mounted on one chip or a plurality of chips. The functional blocks illustrated in FIG. 3 are implemented by cooperation between hardware and software, and therefore, it will be understood by those skilled in the art that these functional blocks can be achieved in various forms by hardware alone, software alone, or a combination thereof.

The game software 110 includes at least a game program, image data, and sound data. The game program receives information regarding an operation made by the user from the input device 6 and performs arithmetic processing to move a game character in a virtual space. The game image generating section 130 includes a GPU (Graphics Processing Unit) that executes rendering processing and the like, and generates game images. The display processing section 140 outputs the generated game images from the output device 4. Note that the processing unit 100 also includes a game sound generating section that generates game sounds and a sound output section that outputs game sounds, but these are omitted from FIG. 3.

When an event occurs during the progress of a game, the game program outputs event information indicating the event that has occurred. In the game program, the start and end of an activity are coded as events. When starting the activity, the game program outputs event information indicating the occurrence of a start event of the activity. When ending the activity, the game program outputs event information indicating the occurrence of an end event of the activity. For example, in the case where a battle activity against an enemy boss is incorporated into a game, the game program outputs event information including an event ID of a start event of the battle activity at the start of the battle. When a player wins the battle against the enemy boss, the game program outputs event information including an event ID of an end event of the battle activity and information indicating the success of the activity.

A game maker may incorporate various events into a game. When a player character equips itself with a weapon A, the game program outputs event information indicating that the character has been equipped with the weapon A. When a player character uses a recovery medicine B, the game program outputs event information indicating that the recovery medicine B has been used. When a player character strengthens protective gear C, the game program outputs event information indicating that the protective gear C has been strengthened. In this way, various events are coded in the game program, and when an event occurs, the game program outputs event information including an event ID that identifies the event that has occurred.

When acquiring the event information from the game software 110, the event information acquiring section 120 generates play data in which a user account, a game ID, and time information (timestamp) indicating the time when the event occurred are added to the event information, and provides the play data to the transmission processing section 122. The game program may output the event information including the game ID and/or the timestamp to the event information acquiring section 120. The transmission processing section 122 transmits the play data provided from the event information acquiring section 120 to the server device 5 via the communication unit 102. When the event information acquiring section 120 acquires the event information from the game software 110, it is preferable that the event information acquiring section 120 should immediately generate play data to which a timestamp or the like has been added, and the transmission processing section 122 should transmit the play data to the server device 5 on a real time basis.

In the information processing system 1, a process of transmitting play data is performed by all the information processing devices 10 connected to the server device 5, and the server device 5 collects play data of various games from the plurality of information processing devices 10.

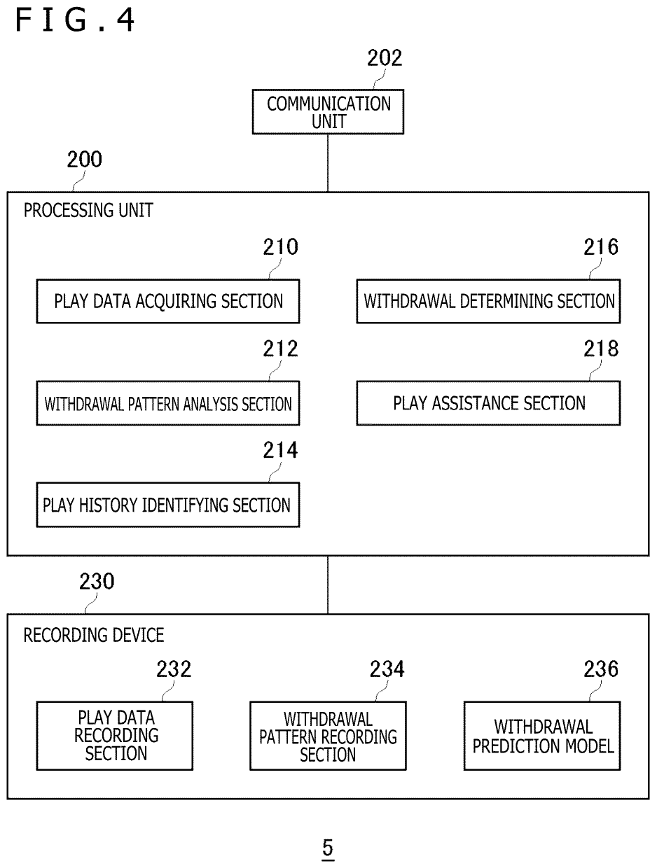

FIG. 4 illustrates functional blocks of the server device 5 according to the embodiment. The server device 5 includes a processing unit 200, a communication unit 202, and a recording device 230. The processing unit 200 includes a play data acquiring section 210, a withdrawal pattern analysis section 212, a play history identifying section 214, a withdrawal determining section 216, and a play assistance section 218. The recording device 230 includes a play data recording section 232, a withdrawal pattern recording section 234, and a withdrawal prediction model 236.

The server device 5 includes a computer which executes programs to obtain various functions illustrated in FIG. 4. The computer includes, as hardware, a memory for loading the programs, one or more processors for executing the loaded programs, an auxiliary storage device, and other LSIs, for example. The processor has a plurality of electronic circuits including a semiconductor integrated circuit and an LSI, and the plurality of electronic circuits may be mounted on one chip or a plurality of chips. The functional blocks illustrated in FIG. 4 are implemented by cooperation between hardware and software, and therefore, it will be understood by those skilled in the art that these functional blocks can be achieved in various forms by hardware alone, software alone, or a combination thereof.

In the embodiment, the server device 5 has a function of analyzing a play pattern (hereinafter, also referred to as a “withdrawal pattern”) in which a withdrawing player has withdrawn from the game, by using past play data, and a function of determining whether or not a user (player) currently playing the game is likely to withdraw from the game, by using the analysis result. These two functions will be described below.

### Analysis Function for Withdrawal Patterns

The play data acquiring section 210 acquires play data indicating the game play status of a plurality of players from the plurality of information processing devices 10, and records the play data in the play data recording section 232. The play data recording section 232 records the play data for each game title, with the play data linked to the player's user account. As mentioned above, the play data includes at least event information, a game ID, and a timestamp.

The withdrawal pattern analysis section 212 analyzes past play data of a plurality of withdrawing players recorded in the play data recording section 232, to derive a play pattern specific to the withdrawing player (a withdrawal pattern). At this time, the withdrawal pattern analysis section 212 may derive the withdrawal pattern by performing statistical processing on the play data of the withdrawing players and the play data of players who have cleared the game without withdrawing.

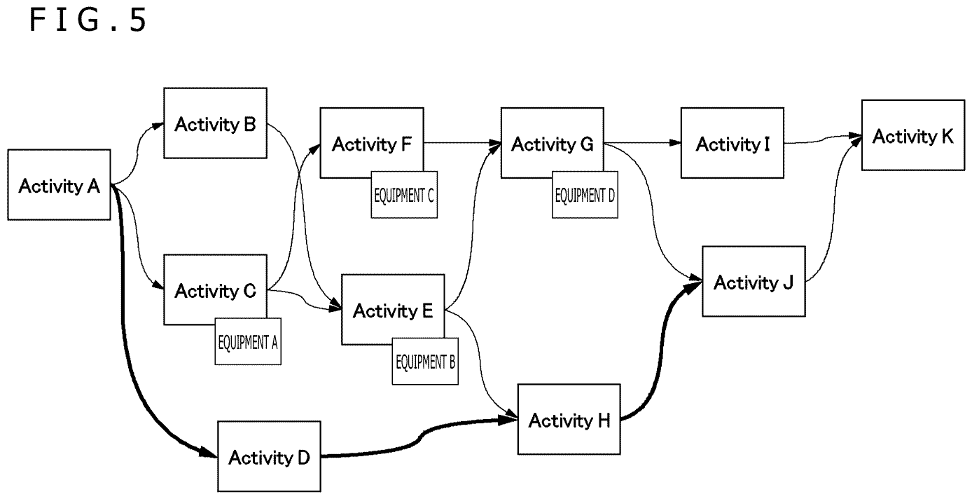

FIG. 5 illustrates an example of past play patterns of a plurality of players. This example illustrates the transition of activities played from an activity A to an activity K.

An example of activity transitions for players A and B who have cleared the game will be described below.

### Play Pattern of Player A

The player A performed the activities in the order of the activity A, the activity C, the activity F, the activity G, the activity I, and the activity K, and then cleared the game. In this play pattern, the player A got equipment A in the activity C, equipment C in the activity F, and equipment D in the activity G.

### Play History of Player B

The Player B performed the activities in the order of the activity A, the activity B, the activity E, the activity H, the activity J, and the activity K, and then cleared the game. In this play pattern, the player B got equipment B in the activity E.

Next, an example of activity transitions for a player C who has withdrawn from the game will be illustrated.

### Play Pattern of Player C

The Player C performed the activities in the order of the activity A, the activity D, the activity H, and the activity J, and withdrew from the game while performing the activity J. In this play pattern, the player C did not get any equipment.

The withdrawal pattern analysis section 212 identifies, from the player C's play pattern, the order in which the activity J and the activities performed prior thereto were performed, and the fact that the player C did not have any equipment when performing the activity J, and infers that these are the reasons why the player C withdrew from the game.

Here, the player B, who performed the same activity J, had the equipment B when performing the activity J. In other words, the player B played the activity J with the equipment B and proceeded to the activity K after playing the activity J. Accordingly, the withdrawal pattern analysis section 212 can infer that the player C was unable to obtain the equipment B when performing the activity A, the activity D, and the activity H, which caused the player C to have difficulty in playing the activity J and lowered his or her motivation for the game, which is why the player C withdrew from the game.

Therefore, the withdrawal pattern analysis section 212 identifies a play pattern in which a player performs activities, namely, the activity A, the activity D, the activity H, and the activity J in this order, without having the equipment B, as a play pattern with a high possibility of withdrawal from the game. Note that the withdrawal pattern analysis section 212 preferably confirms that the proportion of players who withdrew from the game is high in all the players who performed activities, namely, the activity A, the activity D, the activity H, and the activity J in this order, without having the equipment B, and then identifies the relevant play pattern as a play pattern with a high possibility of withdrawal from the game.

For example, the withdrawal pattern analysis section 212 may define a play pattern on the basis of the order of activities and the state of held equipment, and obtain the proportion of the withdrawing players in all players who have played with the same play pattern. Here, if the proportion of the withdrawing players is equal to or greater than a predetermined value, the withdrawal pattern analysis section 212 may determine that the relevant play pattern is one that is likely to result in withdrawal from the game.

Although a description of the analysis process in the withdrawal pattern analysis section 212 has been made above for easy understanding, the withdrawal pattern analysis section 212 identifies play patterns that are likely to result in withdrawal from the game (withdrawal patterns), by statistically processing past play data of many players. The withdrawal pattern analysis section 212 records the identified withdrawal patterns in the withdrawal pattern recording section 234. This statistical processing may be performed periodically. By analyzing past play data of many players, the withdrawal pattern analysis section 212 becomes able to find various withdrawal patterns.

It is to be noted that the withdrawal pattern analysis section 212 may generate a model for predicting the possibility of withdrawal, by machine learning.

The withdrawal pattern analysis section 212 generates the withdrawal prediction model 236 for determining (predicting) whether the possibility of withdrawal is high or low, by machine learning. In generating the withdrawal prediction model 236, the withdrawal pattern analysis section 212 uses past play data of a plurality of players and a label indicating whether or not a player has withdrawn from the game, as teacher data, to perform machine learning regarding the high or low possibility of withdrawal and generates the withdrawal prediction model 236. When referring to a history of play data of a certain player and determining that the game has been cleared by the player, the withdrawal pattern analysis section 212 assigns, to the play data, a label indicating that the player has not withdrawn from the game. When referring to play data of a certain player and determining that the game has not been cleared by the player, the withdrawal pattern analysis section 212 assigns, to the play data, a label indicating that the player has withdrawn from the game. The withdrawal prediction model 236, which has experienced machine learning by using this teacher data, outputs information indicating whether or not there is a high possibility of withdrawal, when receiving a history of play data up to now of a user currently playing the game.

### Withdrawal Determination Function

Next, a withdrawal determination function performed by the server device 5 will be described.

When a user is playing a game, the play data acquiring section 210 acquires play data from the information processing device 10 on a real time basis and records the play data in the play data recording section 232. The play history identifying section 214 acquires the history of the play data of the user currently playing the game from the play data recording section 232 on a real time basis. When the user's play data is additionally recorded in the play data recording section 232, the play history identifying section 214 preferably acquires the added play data and identifies the most recent history of the play data.

The withdrawal determining section 216 determines whether or not the user is likely to withdraw from the game, on the basis of the user's latest play data history. The withdrawal determining section 216 may determine whether or not the user who is currently playing the game is likely to withdraw from the game, by referring to the withdrawal pattern recorded in the withdrawal pattern recording section 234.

Here, it is assumed that the play data history of the currently playing user indicates that the user has finished playing the activity A, the activity D, and the activity H and has now started playing the activity J without having the equipment B. The withdrawal pattern recording section 234 has recorded a play pattern in which activities are performed in the order of the activity A, the activity D, the activity H, and the activity J without having the equipment B, as one of the withdrawal patterns. The withdrawal determining section 216 determines that there is a high possibility that the user will withdraw from the game, in the case where the user's latest play data history matches the withdrawal pattern recorded in the withdrawal pattern recording section 234.

Therefore, in the case where the user's latest play data history does not match the withdrawal pattern recorded in the withdrawal pattern recording section 234, the withdrawal determining section 216 determines that the user is unlikely to withdraw from the game. Accordingly, in the case where the user plays the activity A, the activity D, and the activity H with the equipment B and then starts playing the activity J, the withdrawal determining section 216 may determine that the user is unlikely to withdraw from the game, because the user's play data history does not match the withdrawal pattern with respect to the equipment.

Note that the withdrawal determining section 216 may use the withdrawal prediction model 236 to determine whether or not the user currently playing the game is likely to withdraw from the game. When the withdrawal determining section 216 inputs the user's play data history to the withdrawal prediction model 236, which is a trained model, the withdrawal prediction model 236 outputs information indicating whether or not the user is likely to withdraw from the game. The withdrawal determining section 216 receives the output of the withdrawal prediction model 236 and determines whether or not the user is likely to withdraw from the game. In the above example, in the case where the user's play data history indicates that the user has finished playing the activity A, the activity D, and the activity H without having the equipment B and has now started playing the activity J, the withdrawal prediction model 236 outputs information indicating that the user is likely to withdraw from the game, when the play data history is input thereinto.

As described above, the withdrawal determining section 216 determines, while the user is playing, whether or not the user is likely to withdraw from the game, on the basis of the latest history of the user's play data. Here, in the case where the withdrawal determining section 216 determines that the user is likely to withdraw from the game, the play assistance section 218 performs an assistance process related to game play before the user ends the game play (i.e., while the user is playing the game). This assistance process is a process for reducing the probability that the user will withdraw from the game, and the play assistance section 218 may perform the following assistance process, for example.

### Presenting Support Information to User

In order to reduce the probability that the user will withdraw from the game, the play assistance section 218 transmits information which is for supporting the user's game play and which is to be presented to the user, to the user's information processing device 10 via the communication unit 102. In the information processing device 10, the support information acquiring section 150 acquires the support information and provides the support information to the display processing section 140, which then displays the support information on the output device 4 and presents the support information to the user.

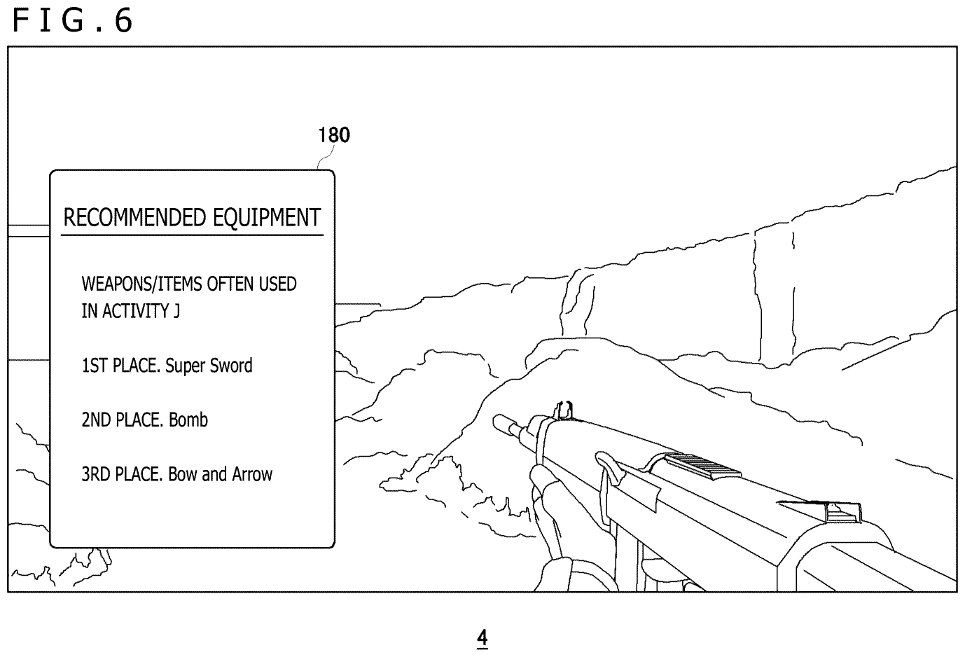

FIG. 6 illustrates an example of a system screen displayed on the output device 4 during game play. The display processing section 140 generates a system image 180 from the support information acquired by the support information acquiring section 150, and displays the image on the output device 4. The system image 180 displays a list of weapons/items that are frequently used in the activity J. By seeing the equipment information displayed in the system image 180, a user currently playing the activity J can be aware of weapons/items recommended for playing the activity J and obtain a clue for conquering the activity J. This can increase the possibility that the user will clear the activity J, and ultimately reduce the probability that the user will withdraw from the game.

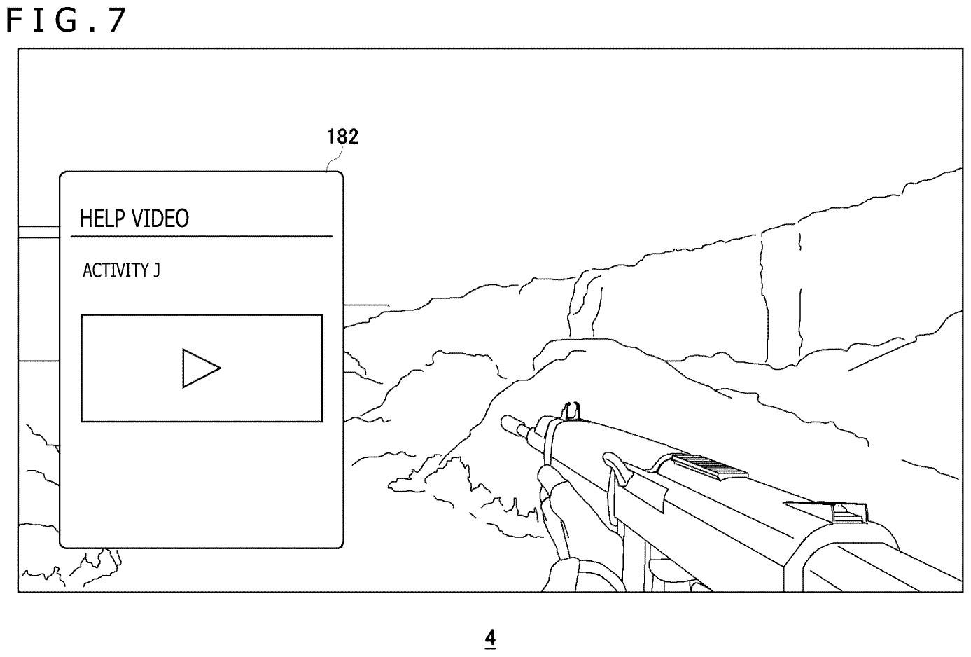

FIG. 7 illustrates another example of the system screen displayed on the output device 4 during game play. The display processing section 140 generates a system image 182 from the support information acquired by the support information acquiring section 150, and displays the image on the output device 4. The system image 182 has an area for reproducing a help video for conquering the activity J, and the help video is reproduced by a user's operation. Note that the system image 182 may display link information for accessing the help video, instead of displaying the help video itself. The user currently playing the activity J can obtain a clue for conquering the activity J by watching the help video. This can increase the possibility that the user will clear the activity J, and can therefore reduce the probability that the user will withdraw from the game.

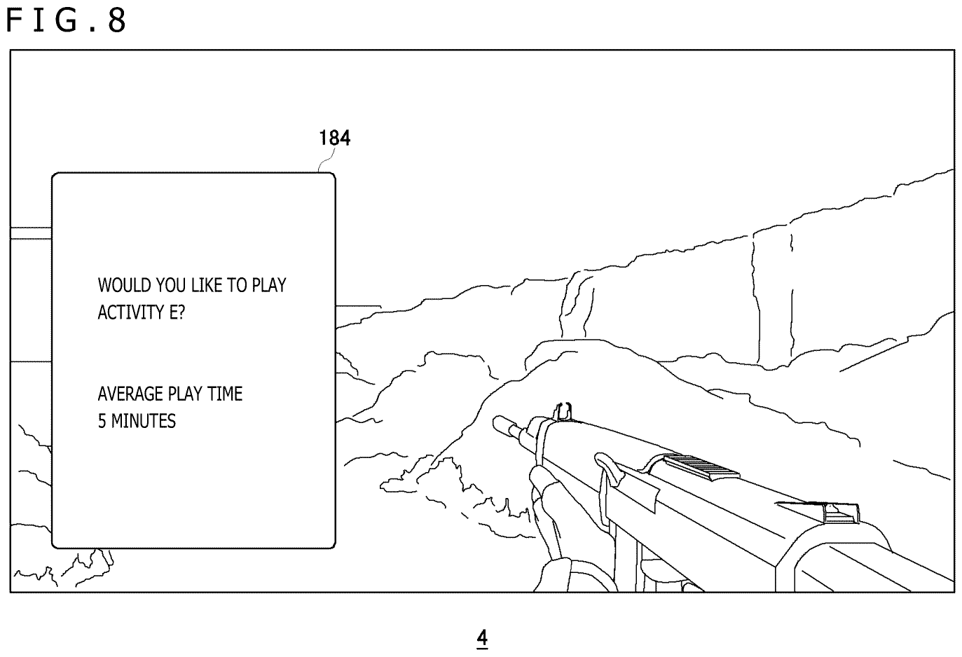

FIG. 8 illustrates still another example of the system screen displayed on the output device 4 during game play. The display processing section 140 generates a system image 184 from the support information acquired by the support information acquiring section 150, and displays the image on the output device 4. The system image 184 displays a suggestion for another activity (activity E in the example illustrated in FIG. 8) in place of the activity J. The suggested other activity may be an easy activity or a popular activity. The user currently playing the activity J is given an opportunity to change the activity to be played, by seeing this suggestion. For example, the system image 184 displayed in a card format may be a GUI (graphical user interface), and the activity E may automatically be started when the user selects and operates the system image 184. In this way, it is possible to reduce the probability that the user will withdraw from the game, by guiding the user from the activity J, which has a high withdrawal probability, to another activity E and allowing the user to experience a sense of accomplishment.

### Providing Support Information to Game

In order to reduce the probability that the user will withdraw from the game, the play assistance section 218 transmits information which is for supporting the user's game play and which is to be provided to the game, to the user's information processing device 10 via the communication unit 102. In the information processing device 10, the support information acquiring section 150 acquires the support information and provides the support information to the game software 110, which performs a process of supporting the user's game play on the basis of the support information.

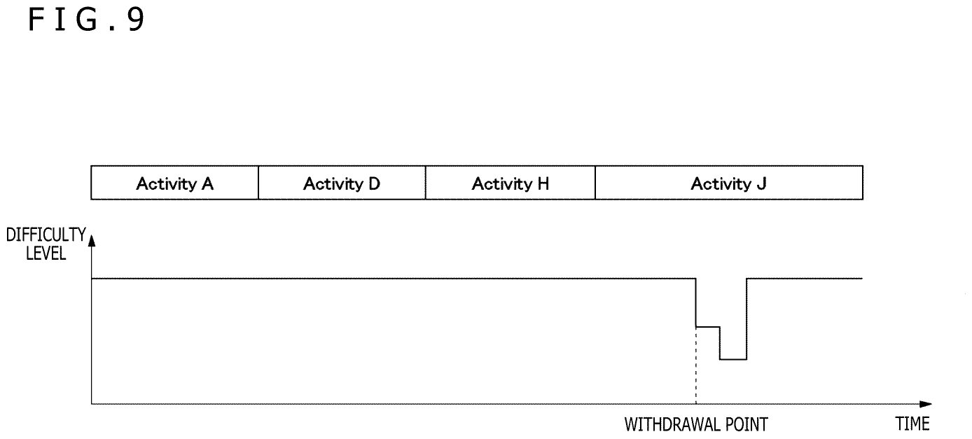

FIG. 9 illustrates an example in which the game software 110 adjusts a game difficulty level on the basis of the support information. In the case where the withdrawal pattern analysis section 212 identifies a point in the activity J where many players have been unable to overcome in the past and have withdrawn (withdrawal point), the play assistance section 218 transmits support information giving an instruction to lower the difficulty level at the withdrawal point, to the information processing device 10. The withdrawal point may be identified as a coordinate value in the game world (for example, a place where a strong enemy character is hiding) or as the timing of encountering a specific enemy character in the game world.

The game software 110 performs a process of lowering the game difficulty level at the withdrawal point on the basis of the support information. In the case where the withdrawal point is set as a battle with an enemy character, the game software 110 may make adjustments such as weakening the enemy character or reducing damage to the player character. In this case, the game software 110 may lower the difficulty level in a stepwise manner until the player defeats the enemy character. After the player character defeats the enemy character, the game software 110 may return the game difficulty level to the original setting value. By lowering the difficulty level at the withdrawal point in this manner, the possibility that the user will defeat the enemy character can be increased, and therefore, the probability that the user will withdraw from the game can be reduced.

Moreover, the game software 110 may cause weapons, recovery medicines, and the like useful for conquering the game to appear at the withdrawal point, so that the player character can use these items. Note that, in the case where a withdrawal point is not provided to the game software 110, the game software 110 may lower the difficulty level or provide useful items on the basis of the support information from the start of the activity J.

The present disclosure has been described above on the basis of the embodiment. The embodiment is merely an example, and it will be understood by those skilled in the art that various modifications are possible in the combination of the respective components and the respective processing steps and that such modifications are also within the scope of the present disclosure.

### INDUSTRIAL APPLICABILITY

The present disclosure relates to a technology for assisting a user in playing a game.

### REFERENCE SIGNS LIST

1: Information processing system
5: Server device
10: Information processing device
100: Processing unit
102: Communication unit
110: Game software
120: Event information acquiring section
122: Transmission processing section
130: Game image generating section
140: Display processing section
150: Support information acquiring section
200: Processing unit
202: Communication unit
210: Play data acquiring section
212: Withdrawal pattern analysis section
214: Play history identifying section
216: Withdrawal determining section
218: Play assistance section
230: Recording device
232: Play data recording section
234: Withdrawal pattern recording section
236: Withdrawal prediction model

1. A server device comprising:
one or more processors having hardware, wherein
the one or more processors
acquire a history of play data of a user who is playing a game, and
perform an assistance process related to a game play before the user ends the game play, in a case of determining from the history of the play data of the user that there is a high possibility that the user withdraws from the game.

2. The server device according to claim 1, wherein the one or more processors determine that there is a high possibility that the user withdraws from the game, in a case where the history of the play data of the user matches a predetermined play pattern.

3. The server device according to claim 2, wherein
the one or more processors analyze past play data of a plurality of players to identify a play pattern of a player who has withdrawn from the game,
record the identified play pattern as a withdrawal pattern, and
determine that there is a high possibility that the user withdraws from the game, in a case where the history of the play data of the user matches the withdrawal pattern.

4. The server device according to claim 1, wherein the one or more processors determine whether or not there is a high possibility that the user withdraws from the game, by inputting the history of the play data of the user into a trained model generated by machine learning using, as teacher data, past play data of a plurality of players and a label indicating whether or not a player has withdrawn from the game.

5. The server device according to claim 1, wherein the one or more processors transmit, to an information processing device of the user, information that is for supporting the game play of the user and that is to be presented to the user.

6. The server device according to claim 1, wherein the one or more processors transmit, to an information processing device of the user, information that is for supporting the game play of the user and that is to be provided to the game.

7. An information processing device operated by a user, the information processing device comprising:
one or more processors having hardware, wherein
the one or more processors
transmit play data of the user who is playing a game to a server device, and
present support information to the user or provide the support information to the game, the support information being transmitted from the server device on a basis of a history of the play data of the user.
